(19) United States
(12) Patent Application Publication
(10) Pub. No.: US 2007/0116458 A1
(43) Pub. Date: May 24, 2007

(54) Methods and systems for operating a pan tilt zoom camera

(76) Inventor: Kenneth McCormack, Albany, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/282,189

(22) Filed: Nov. 18, 2005

(51) Int. Cl. G03B 17/00

(52) U.S. Cl. 396/427

(57) ABSTRACT

Methods and systems for a video surveillance system are provided. The system includes a video camera assembly including a base, a first pan/tilt mechanism, and a second pan/tilt mechanism. The first pan/tilt mechanism is removably coupled to the base. The second pan/tilt mechanism is configured to be coupled to the base in replacement of the first pan/tilt mechanism. The system also includes a memory configured to store pan/tilt mechanism positional calibration information, and a controller communicatively coupled to the first pan/tilt mechanism configured to receive positional calibration information for the first pan/tilt mechanism, store the positional calibration information to the memory, retrieve the positional calibration information from the memory when the first pan/tilt mechanism is removed and replaced with the second pan/tilt mechanism, and download the retrieved positional calibration information for use by the second pan/tilt mechanism.

### BACKGROUND OF THE INVENTION

This invention relates generally to video surveillance systems and, more particularly, to assembling and disassembling camera pan, tilt, and zoom assemblies.

At least some known video surveillance systems include one or more video cameras mounted in a housing along with a pan, tilt, and zoom (PTZ) assembly. The PTZ permits controlling a movement of the camera to align a viewing area of the camera with an object of interest or location of interest. The zoom portion of the mechanism may be used to adjust a field of view of the camera. The housing protects the camera from the environment in the location where the camera and PTZ assembly are mounted.

At least some known video camera assemblies are equipped with “preset” controls, for example, servo mechanisms to position the camera to internally stored pan, tilt, zoom, focus, and iris positions. Using the position data, a plurality of “preset” views for each camera is stored and used to direct the respective camera to one, or a sequence of these preset views in response to operating a key on the keypad or from logic in a system control that automatically determines a desired view or sequence.

During initial installation and periodically thereafter, the camera and/or PTZ assembly may need to be removed from its mounted location. For example, over time, the camera and/or PTZ assembly may require maintenance to restore a damaged or worn camera or PTZ assembly to an operable condition. However, mechanical inaccuracies in the pan/tilt assemblies typically necessitate the presets being reprogrammed after the video camera assemblies are replaced.

### BRIEF DESCRIPTION OF THE INVENTION

In one embodiment, a video surveillance system includes a video camera assembly including a base, a first pan/tilt mechanism, and a second pan/tilt mechanism. The first pan/tilt mechanism is removably coupled to the base. The second pan/tilt mechanism is configured to be coupled to the base in replacement of the first pan/tilt mechanism. The system also includes a memory configured to store pan/tilt mechanism positional calibration information, and a controller communicatively coupled to the first pan/tilt mechanism configured to receive positional calibration information for the first pan/tilt mechanism, store the positional calibration information to the memory, retrieve the positional calibration information from the memory when the first pan/tilt mechanism is removed and replaced with the second pan/tilt mechanism, and download the retrieved positional calibration information for use by the second pan/tilt mechanism.

In another embodiment, a method of operating a video camera assembly includes storing position calibration information for a first pan/tilt mechanism, replacing the first pan/tilt mechanism with a second pan/tilt mechanism, and downloading the stored position calibration information for use by the second pan/tilt mechanism.

In yet another embodiment, a method of maintaining a video camera assembly includes determining position calibration information for a first pan/tilt mechanism associated with the assembly, and storing the position calibration information. The method also includes replacing the first pan/tilt mechanism with a second pan/tilt mechanism, commanding the second pan/tilt mechanism to a predetermined preset address, acquiring an image at the predetermined preset address, processing the image to determine primitive geometries of the image, comparing the determined primitive geometries to primitive geometries stored in the position calibration information to determine a positional calibration information correction, and applying the correction to the positional calibration information associated with the second pan/tilt assembly.

### BRIEF DESCRIPTION OF THE DRAWINGS

FIG. 1 is a schematic view of an exemplary video surveillance system in accordance with an embodiment of the present invention;

FIG. 2 is a perspective view of an exemplary video camera pan, tilt, and zoom (PTZ) assembly that may be used with the system shown in FIG. 1; and

FIG. 3 is a flowchart of an exemplary method 300 of storing and transferring preset information from a camera being removed from operation to a replacement camera.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

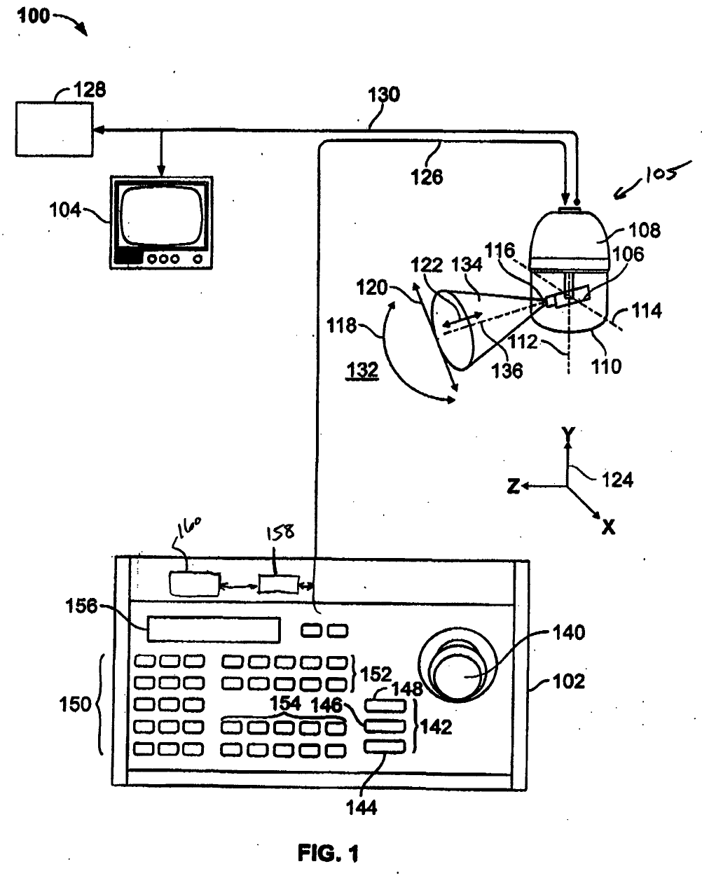

FIG. 1 is a schematic view of an exemplary video surveillance system 100 in accordance with an embodiment of the present invention. Video surveillance system 100 includes a control panel 102, a display monitor 104, and a pan, tilt, and zoom (PTZ) assembly 105. Typically, a camera 106 is housed in an enclosure 108 having a dome 110 for protecting camera 106 from the environment where camera 106 is located. In one embodiment, dome 110 is tinted to allow camera 106 to acquire images of the environment outside of enclosure 108 and simultaneously prevent individuals in the environment being observed by camera 106 from determining the orientation of camera 106. In various alternative embodiments, dome 110 is not tinted. In the exemplary embodiment, camera 106 includes capabilities to pan about a vertical axis 112, tilt about a horizontal axis 114, and control a lens assembly 116 to cause camera 106 to zoom. For example, PTZ assembly 105 includes a pan motor and encoder 113 and tilt motor and encoder 115. The encoders determine an angular position of the pan and tilt motor and generate position signals that are used with a zoom setting to determine an area in the field of view. Panning movement of camera 106 is represented by an arrow 118, tilting movement of camera 106 is represented by arrow 120 and the changing of the focal length of lens assembly 116 of camera 106, i.e., zooming, is represented by arrow 122. As shown with reference to a coordinate system 124, panning motion may track movement along the x-axis, titling motion may track movement along the y-axis and focal length adjustment may be used to track movement along the z-axis. Signals representing commands to control such capabilities are transmitted from control panel 102 through a control data line 126. Image data signals are transmitted from camera 106 to display monitor 104 and a storage device 128 through a video data line 130.

Lens assembly 116 views an area of a location 132, which may be remote from control panel 102 and is in a field of view 134 and along a viewing axis 136 of lens assembly 116. Images of location 132 are converted by camera 106 into an electrical video signal, which is transmitted to display monitor 104.

In the exemplary embodiment, control panel 102 includes an X-Y control joystick 140 that is used to generate pan and tilt commands. A plurality of rocker-type switches 142 are used to control a zoom 144, a focus 146, and an iris 148 of lens assembly 116. In an alternative embodiment, joystick 140 includes a twist actuation that is used to control the zoom of camera 106. Joystick 140 may also incorporate triggers and/or buttons to facilitate operating various controls associated with system 100. Control panel 102 also includes a numeric keypad 150 for entering numbers and values. In an alternative embodiment, control panel 102 may include an alpha or alphanumeric keypad (not shown) for entering text as well as numbers. Control panel 102 further includes a plurality of preset switches 152 that may be programmed to execute macros that automatically control the actions of camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected camera.

A processor 158 receives programmed instructions, from software, firmware, and data from memory 160 and performs various operations using the data and instructions. Processor 158 may include an arithmetic logic unit (ALU) that performs arithmetic and logical operations and a control unit that extracts instructions from memory 160 and decodes and executes them, calling on the ALU when necessary. Memory 160 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 160 may include an operating system, which executes on processor 158. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 160 may include storage locations for the preset macro instructions that may be accessible using one of the plurality of preset switches 142.

As used herein, the terms “software” and “firmware” are interchangeable, and include any computer program stored in memory for execution by processor 158, including RAM memory, ROM memory, EPROM memory, EEPROM memory, and non-volatile RAM (NVRAM) memory. The above memory types are exemplary only, and are thus not limiting as to the types of memory usable for storage of a computer program.

In various embodiments, processor 158 and memory 160 are located external to camera 106 such as in control panel 102 or in a PC or other standalone or mainframe computer system capable of performing the functions described herein.

In the exemplary embodiment, video surveillance system 100 is a single camera application, however, various embodiments of the present invention may be used within a larger surveillance system having additional cameras which may be either stationary or moveable cameras or some combination thereof to provide coverage of a larger or more complex surveillance area. In an alternative embodiment, one or more video recorders (not shown) are connected to control panel 32 to provide for recording of video images captured by camera 13 and other cameras in system 100.

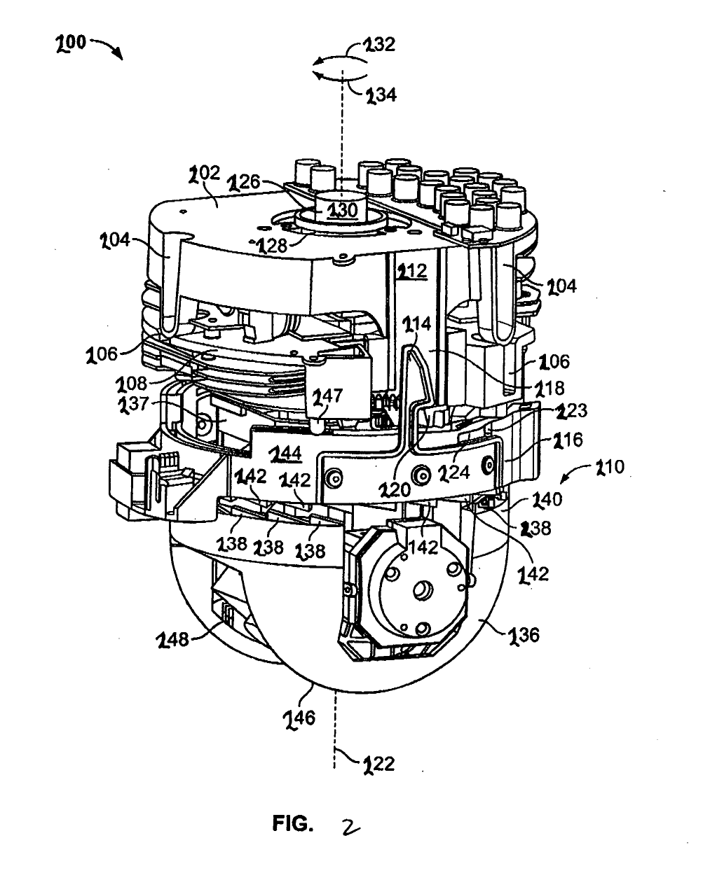

FIG. 2 is a perspective view of an exemplary video camera pan, tilt, and zoom (PTZ) assembly 200 that may be used with system 100 (shown in FIG. 1). PTZ assembly 200 includes an upper bracket or base 202 coupled to an interior portion of a housing. The housing is configured to be fixedly coupled to a structure such as a ceiling, stanchion, post, or other suitable mount able to support the weight of PTZ assembly 200 and is a stable platform to facilitate reducing jitter. Jitter may be apparent in the camera image due to vibration or swaying of PTZ assembly 200.

Base 202 includes one or more locating rounds 204 that are complementary to locating slots 206 in a lower bracket 208 of a removable unit 210. Locating rounds and locating slots 206 are used to align removable unit 210 and base prior to coupling removable unit 210 to base 202. Base 202 also includes one or more guides 212 configured to receive a pawl 214 coupled to a ring latch 216 on removable unit 210. In the exemplary embodiment, a second pawl (not shown) is oriented similarly to pawl 214 and spaced approximately 180° from pawl 214. In an alternative embodiment, a different number of pawls are used. A distal end 218 of guide 212 includes a pin 220 extending away from guide 212 in a radial direction with respect to a longitudinal axis 222 of PTZ assembly 200. Pawl 214 and pin 220 are configured to engage to transfer the weight of removable unit 210 to base 202 to support removable unit 210. In various embodiments of the present invention pin 220 is configured as a rotatable wheel.

Ring latch 216 is rotatably coupled to lower bracket 208. The amount of rotation ring latch 216 is capable of is limited by a plurality of stops 223 and complementary grooves 224 that engage to limit the rotational travel of ring latch 216 with respect to lower bracket 208. A stationary member 228 of pan motor 226 is fixedly coupled to lower bracket 208. When pan motor 226 rotates, removable unit 210 rotates with the rotatable member and with respect to base 202. A slip ring 230 permits removable unit 210 to rotate continuously in a first rotational direction 232 or a second opposite direction 234.

Removable unit 210 includes a shroud 236 that is slidably coupled to a chassis 237. Shroud 236 is configured to maintain a relaxed position (shown in FIG. 1) and an engaged position. In the engaged position, a plurality of teeth 238 arranged circumferentially about an outer periphery 240 of shroud 236 and extending axially toward ring latch 216 are configured to mesh with a complementary plurality of teeth 242 arranged circumferentially about an outer periphery 244 of ring latch 216 and extending axially toward teeth 238. Shroud 236 is translated from the relaxed position to the engaged position by applying an upward axial force to a bottom side 246 of shroud 236. The movement associated with positioning shroud 236 from the relaxed position to the engaged position compresses or tensions a plurality of bias members 248 coupled between shroud 236 and chassis 237. A plurality of travel limiters 247 limit the upward movement of ring latch 216 with respect to lower bracket 208. Bias members 248 are configured to return shroud 236 to the relaxed position when the axial force applied to shroud 236 is removed.

Ring latch 216 is configured to rotate at least partially about axis 222 and shroud 236 is configured to rotate freely about axis 222 with chassis 237 and the rotatable member of pan motor 228. Accordingly, with teeth 238 and 242 engaged by an axial force applied to shroud 236, an additional rotational force may be applied to shroud 236 to cause ring latch to rotate. Pawl 214 rotates with ring latch 216 toward or away from pin 220. If pawl 214 rotates away from pin 220, the weight of removable unit 210 will no longer be supported by the engagement of pawl 214 and pin 220 and removable unit 210 will be released from base 202 by its own weight. In an alternative embodiment, one or more ejection springs are configured to apply a bias force to removable unit 210 to assist in disengaging removable unit 200 from base 202.

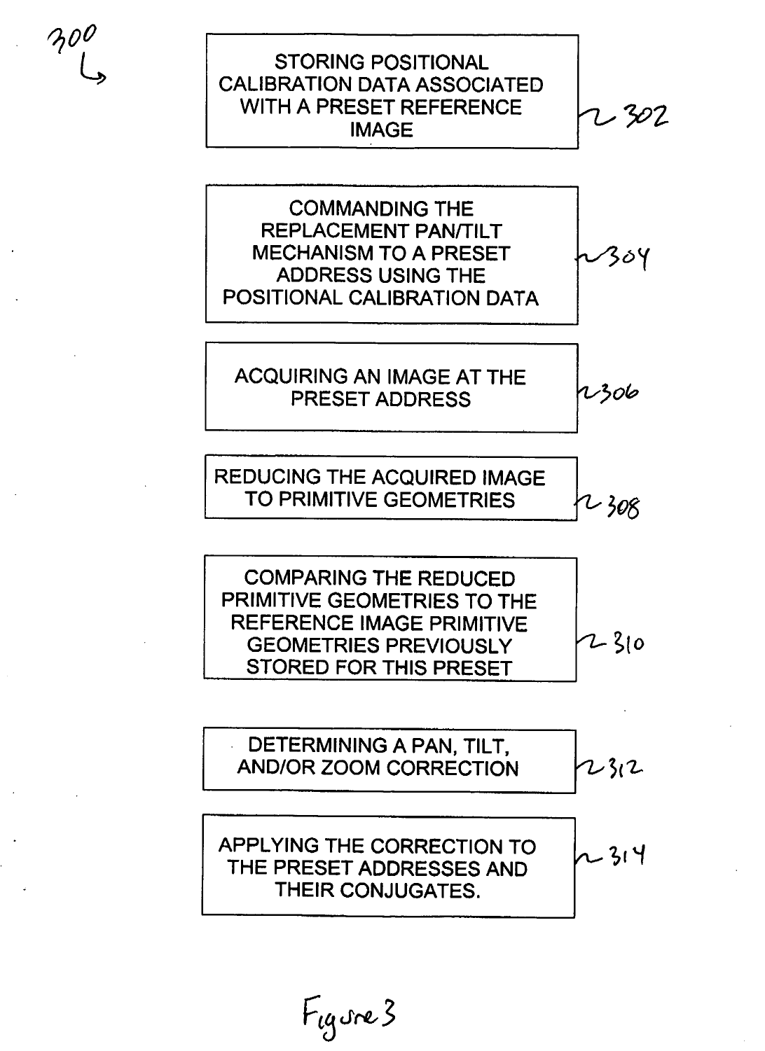

FIG. 3 is a flowchart of an exemplary method 300 of storing and transferring preset information from a camera being removed from operation to a replacement camera. Method 300 includes storing 302 primitive geometries associated with a preset reference image. The primitive geometries are extracted from the reference image associated with a respective preset address or plurality of addresses. For example, a preset may be able to be addressed using a single address or in the case of a camera that can tilt 180° or greater a preset location may be addressable using more than one address. As used herein, primitive geometries describe relatively simple shapes and combinations of shapes that are extracted from images that are characteristic of the image and are able to be used to differentiate the image from other images the camera is able to acquire. The set of primitive geometries typically take up less memory resources than a full image. The preset addresses, respective primitive geometries, and associated encoder position information are stored in a memory in a base associated with the camera to facilitate maintaining preset accuracy.

When a camera is replaced, positional calibration data including, for example, the preset addresses, respective primitive geometries, and associated encoder position information are automatically downloaded into a memory associated with the camera. The accuracy and repeatability is limited by two factors; one, current camera calibration, and two, the mechanical installation tolerances of the camera and the camera bracket. Removing and reinstalling a replacement camera, which inherits the presets determined by the previous camera, can also cause drifts, particularly on high zoom presets due to the calibration variation between the cameras. When a replacement camera is first installed the presets are tested for accuracy.

The replacement camera is commanded 304 to a preset address using the positional calibration data. In the exemplary embodiment, the replacement camera automatically initiates and executes a script, macro, or program to command the replacement camera to point to the view addressed by the downloaded encoder position information. An image is then acquired 306 at the preset address indicated by the downloaded encoder position information. The acquired image is reduced 308 to primitive geometries in the same manner as the primitive geometries were extracted from the preset reference image. The primitive geometries extracted from the acquired image are compared 310 to the primitive geometries from the reference image previously stored for this preset. From the comparison a pan, tilt, and/or zoom correction is determined 312, and then the correction is applied 314 to the preset addresses and their conjugates for the replacement camera. The replacement camera may selectably perform the same calibration for all the presets associated with the replacement camera or may only perform the calibration for a selectable number of presets less than all of the presets. When less than all of the presets are calibrated using the method described herein, corrections for the non-calibrated presets are inferred from the calibrations performed. For example, calibrations for non-calibrated cameras may be simple interpolations of the performed calibrations. In an alternative embodiment, the correction factor is determined by searching for a systematic drift of the presets that are calibrated. The determined correction factor would be a value that minimized the preset error over the calibration set. The accuracy using this technique removes the two major uncertainties in the system, namely the encoder calibration variance and the mechanical coupling of the camera into the installation bracket.

The above-described embodiments of a video surveillance system provide a cost-effective and reliable means for enabling an operator to transfer preset information from one camera to a replacement camera without substantial loss in accuracy of the preset data.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components.

A technical effect of the various embodiments of the systems and methods described herein include facilitating operation of the video surveillance system by transferring preset information from one camera to another without substantial loss in accuracy of the preset data to facilitate replacement of the camera assembly in with a minimum of time.

While the invention has been described in terms of various specific embodiments, those skilled in the art will recognize that the invention can be practiced with modification within the spirit and scope of the claims.

What is claimed is:

1. A video surveillance system comprising:
a video camera assembly comprising:
a base;
a first pan/tilt mechanism removably coupled to said base, said first pan/tilt mechanism comprising a position encoder and a video camera, said first pan/tilt mechanism configured to rotate the video camera about at least one of a pan axis and a tilt axis to at least one preset address; and
a second pan/tilt mechanism configured to be coupled to said base;
a memory configured to store pan/tilt mechanism positional calibration information; and
a controller communicatively coupled to said first pan/tilt mechanism, said controller configured to:
receive positional calibration information for said first pan/tilt mechanism;
store the positional calibration information to said memory;
retrieve the positional calibration information from said memory when said first pan/tilt mechanism is removed and replaced with the second pan/tilt mechanism; and
download the retrieved positional calibration information for use by said second pan/tilt mechanism.

2. An assembly in accordance with claim 1 wherein said memory is located in said base.

3. An assembly in accordance with claim 1 wherein said controller is located in said base.

4. An assembly in accordance with claim 1 wherein said encoder comprises a stationary portion coupled to at least one of said base and a pan portion of said pan/tilt mechanism, and a rotatable portion coupled to at least one of the pan portion of said pan/tilt mechanism and a tilt portion of the pan/tilt mechanism.

5. An assembly in accordance with claim 1 wherein the positional calibration information comprises at least one of encoder data, pan/tilt mechanism address data, and primitive geometries.

6. An assembly in accordance with claim 5 wherein the encoder data comprises at least one of relative pan position data and relative tilt position data.

7. An assembly in accordance with claim 5 wherein said address data includes an angular position of a pan portion of said pan/tilt mechanism, an angular position of a tilt portion of the pan/tilt mechanism, and a zoom setting.

8. An assembly in accordance with claim 5 wherein the primitive geometries comprise at least one of lines, angles, circles, curves and shapes.

9. An assembly in accordance with claim 1 wherein said controller is further configured to:
command said second pan/tilt mechanism to a predetermined preset address included in the positional calibration information;
determine primitive geometries of an image acquired at the predetermined preset address;
determine a positional calibration information correction using the determined primitive geometries and primitive geometries included in the positional calibration information.

10. A method of operating a video camera assembly that includes a base and one of a plurality of interchangeable pan/tilt mechanisms removably coupled to the base, said method comprising:
storing position calibration information for a first pan/tilt mechanism;
replacing the first pan/tilt mechanism with a second pan/tilt mechanism; and
downloading the stored position calibration information for use by the second pan/tilt mechanism.

11. A method in accordance with claim 10 wherein storing position calibration information comprises storing position calibration information in a memory that is located in the base.

12. A method in accordance with claim 10 wherein the video camera assembly includes a controller communicatively coupled to the pan/tilt mechanism coupled to the base and wherein storing position calibration information includes;
receiving positional calibration information for the first pan/tilt mechanism;
storing the positional calibration information for the first pan/tilt mechanism to the memory;
retrieving the positional calibration information for the first pan/tilt mechanism from the memory when the first pan/tilt mechanism is removed and replaced with a second pan/tilt mechanism; and
downloading the retrieved positional calibration information for the first pan/tilt mechanism for use by the second pan/tilt mechanism.

13. A method in accordance with claim 10 wherein storing position calibration information comprises storing position calibration information that includes at least one of pan/tilt mechanism encoder data, pan/tilt mechanism address data, and primitive geometries.

14. A method in accordance with claim 13 wherein storing position calibration information comprises storing encoder data that includes at least one of relative pan position data and relative tilt position data.

15. A method in accordance with claim 13 wherein storing position calibration information comprises storing address data that includes an angular position of a pan portion of the pan/tilt mechanism, an angular position of a tilt portion of the pan/tilt mechanism, and a zoom setting.

16. A method in accordance with claim 13 wherein storing position calibration information comprises storing primitive geometries that include at least one of lines, angles, circles, curves, and shapes.

17. A method in accordance with claim 10 further comprising:
commanding the second pan/tilt mechanism to a predetermined preset address included in the positional calibration information;
determining primitive geometries of an image acquired at the predetermined preset address; and
determining a positional calibration information correction using the determined primitive geometries and primitive geometries included in the positional calibration information.

18. A method of maintaining a video camera assembly comprising:
determining position calibration information for a first pan/tilt mechanism associated with the assembly;
storing the position calibration information;
replacing the first pan/tilt mechanism with a second pan/tilt mechanism; and
commanding the second pan/tilt mechanism to a predetermined preset address;
acquiring an image at the predetermined preset address;
processing the image to determine primitive geometries of the image;
comparing the determined primitive geometries to primitive geometries stored in the position calibration information to determine a positional calibration information correction;
applying the correction to the positional calibration information associated with the second pan/tilt assembly.

19. A method in accordance with claim 18 wherein determining position calibration information comprises determining at least one of encoder data, pan/tilt mechanism address data, and primitive geometries.

20. A method in accordance with claim 18 wherein storing the position calibration information comprises storing the position calibration information offboard the first pan/tilt mechanism.
